(19) United States
(12) Patent Application Publication
(10) Pub. No.: US 2008/0166534 A1
(43) Pub. Date: Jul. 10, 2008

(54) Optical Element and Method for Manufacturing Optical Element

(75) Inventor: Kunihiko Yoshino, Kanagawa-ken (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 11/884,954

(22) PCT Filed: Jan. 30, 2006
(86) PCT No.: PCT/JP06/01435

§ 371 Date: Aug. 23, 2007

(30) Foreign Application Priority Data
Feb. 28, 2005 (JP) 2005-052214

(51) Int. Cl. B32B 7/02; B05D 5/06

(52) U.S. Cl. 428/215; 428/332; 427/162

(57) ABSTRACT

A multilayer optical thin film 4 is formed on the surface of a substrate 1 made of quartz having a thickness of 0.8 mm or less by alternately laminating SiO₂ thin films 2 and Nb₂O₅ thin films 3 for a total of approximately 100 layers. The linear expansion coefficient of the substrate 1 is small, and the difference from that of the multilayer optical thin film 4 is large. Therefore, when the substrate 1 is lowered to ordinary temperature from the film formation state that is normally at approximately 200° C., the compressive stress of the multilayer optical thin film 4 and the thermal stress that is generated as a result of the temperature drop cancel each other out, so that deformation (warpage) of the substrate 1 is alleviated. Accordingly, when the substrate 1 is cut by a dicing saw or the like, working is easy, there is little damage, and the surface precision of the cut-out optical elements is improved.

### TECHNICAL FIELD

The present invention relates to an optical element that is formed by forming a thin film such as a dielectric film on a substrate and a method for manufacturing such an optical element.

### BACKGROUND ART

Optical elements such as interference filters and anti-reflection films that are used in optical communications or the like include optical elements in which desired optical characteristics are obtained by forming a thin film in multiple layers on a glass having a thickness of 1 mm or less and by utilizing interference of light in the multilayer thin film.

Such an optical element is formed, for example, by alternately laminating thin films of SiO₂, which is a substance with a low refractive index, and thin films of Nb₂O₅, Ta₂O₅, TiO₂, ZrO₂, HfO₂, or the like, which are substances with a high refractive index, on a 50-mm square glass substrate (BK7) having a thickness of approximately 0.3 mm (the thickness per each layer of the respective thin films is typically several tens of nanometers to several hundreds of nanometers). Furthermore, there are also cases in which a multilayer thin film is constructed from a film structure in which thin films having a refractive index that is between that of thin films of the low-refractive-index substance and that of thin films of the high-refractive-index substance, e.g., Al₂O₃, are appropriately interposed between layers of such a low-refractive-index substance and high-refractive-index substance.

A sputtering method or an ion beam assisted method is often used for film formation. Following the completion of film formation, a substrate having a multilayer thin film on its surface is cooled to ordinary temperature, cut to a specified size by using a dicing saw or the like, and used as an optical element.

When such optical elements are manufactured, there is a problem in that deflection is generated in the substrate because of the effect of the compressive stress of the multilayer thin film. In this case, the compressive stress refers to a stress that acts so as to stretch the surface of the substrate on the side on which the multilayer thin film is formed; consequently, the substrate following the film formation undergoes deformation so that the side on which the multilayer thin film is formed has a convex shape. Such a compressive stress is estimated to be 50 to 150 MPa in the case of Nb₂O₅ and 150 to 350 MPa in the case of SiO₂.

If this deformation of the substrate exceeds a permissible limit, problems arise in that cutting with a dicing saw or the like becomes difficult, and that breakage occurs during handling. Moreover, there are cases in which a problem occurs in that the surfaces of cut-out optical elements do not become flat. If the surfaces of cut-out optical elements do not become flat, the following problems are encountered: namely, optical characteristics vary depending on the position of the light that is incident on these optical elements, when these minute optical elements are lined up and sandwiched between other optical elements consisting of glass or the like, the surfaces become uneven, so that bonding cannot be accomplished very well, and the like.

### DISCLOSURE OF THE INVENTION

The present invention was devised in light of such circumstances, and it is an object of the present invention is to provide an optical element in which there is little deformation following the completion of film formation, so that handling such as cutting is easy, and which has favorable optical characteristics, and a method for manufacturing such an optical element.

The first means that is used to solve the problems described above is an optical element that is formed by forming a thin film having a compressive stress on a substrate, wherein a material that has a linear expansion coefficient smaller than the linear expansion coefficient of the thin film and that has a thickness of 0.8 mm or less is used as the substrate.

The formation of a thin film is generally accomplished by a sputtering method, ion beam assisted method, or the like, and these are performed at a high temperature. Accordingly, if a material which has a linear expansion coefficient smaller than the linear expansion coefficient of the thin film is used as the substrate, the amount of shrinkage of the thin film becomes greater than the amount of shrinkage of the substrate when the temperature is lowered to ordinary temperature following the completion of film formation. Consequently, the compressive stress of the thin film and the thermal stress that is generated between the substrate and thin film as a result of the temperature drop cancel each other out, so that the amount of deformation of the substrate that is generated by the compressive stress of the thin film can be reduced in a state in which the substrate is at ordinary temperature following the completion of film formation. If the thickness of the substrate is 0.8 mm or greater, the deformation caused by the film stress is reduced, so that the effect of the present means becomes smaller. Therefore, the thickness of the substrate is limited to 0.8 mm or less.

As the thickness of the substrate becomes smaller, e.g., 0.7 mm, 0.6 mm, 0.5 mm, 0.4 mm, 0.3 mm, 0.2 mm, and 0.1 mm, the effect of the present means becomes greater. Furthermore, the present means is not necessarily limited to an optical element in which the thin film is formed by a sputtering method or ion beam assisted method.

The second means that is used to solve the problems described above is the first means, wherein a ratio of the thickness of the thin film to the thickness of the substrate is between 1:80 and 3:1.

The thickness of the thin film of an optical element formed by forming the thin film such as a dielectric film on a substrate is 10 μm to 30 μm in most cases. Furthermore, the thickness of the substrate is 10 μm to 0.8 mm. Accordingly, in cases where the ratio of the thickness of the thin film to the thickness of the substrate is between 1:80 and 3:1, the effect of the first means is especially great.

The third means that is used to solve the problems described above is the first means or second means, wherein the thin film has a multilayer film structure.

The first means and the second means may be used for an optical element having a multilayer film structure in which an interference filter or the like is formed, and if the number of laminated layers increases, it becomes easier to realize various spectral transmittance characteristics. Meanwhile, however, since the stress of the thin film itself also increases, the effect obtained by applying the first means or the second means is especially great in cases where the thin film has a multilayer film structure.

The fourth means that is used to solve the problems described above is any of the first through third means, wherein the material is silica.

In general, the linear expansion coefficient of the thin film is approximately 50×10⁻⁷/K. In contrast, the linear expansion coefficient of silica is approximately 5×10⁻⁷/K, which is an order of magnitude smaller. Therefore, if silica is used as the material of the first means or the second means, the effect is especially great.

The fifth means that is used to solve the problems described above is a method for manufacturing an optical element including a step of forming a thin film having a compressive stress on a substrate, wherein a material that has a linear expansion coefficient smaller than the linear expansion coefficient of the thin film and that has a thickness of 0.8 mm or less is used as the substrate, and a film formation is performed at a temperature which is such that the deformation of the substrate falls within a permissible range when the substrate having the thin film formed on the surface is returned to ordinary temperature following the completion of the film formation.

If a material that has a linear expansion coefficient smaller than the linear expansion coefficient of the thin film is used as the substrate as described above, the compressive stress and thermal stress of the thin film cancel each other out, so that the deformation of the substrate at ordinary temperature can be reduced. The magnitude of the thermal stress when the substrate is returned to ordinary temperature increases as the temperature of the substrate during the film formation increases. Accordingly, if the temperature of the substrate during the film formation is adjusted, the compressive stress and thermal stress of the thin film can be caused to cancel each other out, so that the amount of deformation when the substrate is returned to ordinary temperature can be reduced. Furthermore, the reason for limiting the thickness of the substrate to 0.8 mm or less is the same as in the first means.

As the thickness of the substrate becomes smaller, e.g., 0.7 mm, 0.6 mm, 0.5 mm, 0.4 mm, 0.3 mm, 0.2 mm, and 0.1 mm, the effect of the present means becomes greater.

The sixth means that is used to solve the problems described above is the fifth means, wherein a ratio of the thickness of the thin film to the thickness of the substrate is between 1:80 and 3:1.

The seventh means that is used to solve the problems described above is the fifth means or sixth means, wherein the thin film has a multilayer film structure.

The eighth means that is used to solve the problems described above is any of the fifth through seventh means, wherein the material is silica.

### BRIEF DESCRIPTION OF THE DRAWINGS

FIG. 1 is a diagram used to illustrate a method for manufacturing an optical element constituting one working configuration of the present invention.

### BEST MODE FOR CARRYING OUT THE INVENTION

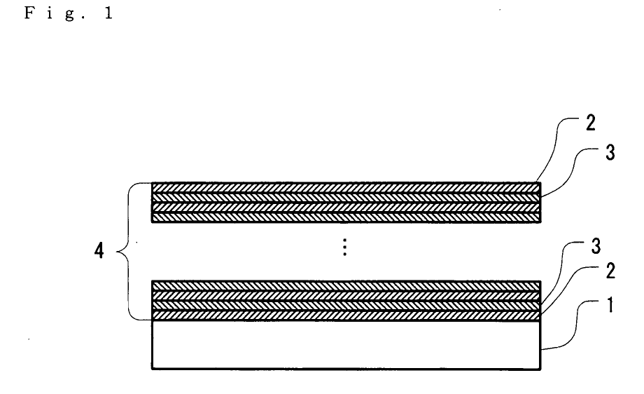

A working configuration of the present invention will be described below using the FIGURE. FIG. 1 is a diagram used to illustrate a method for manufacturing an optical element constituting one working configuration of the present invention. A multilayer optical thin film 4 is formed on the surface of a substrate 1 made of silica (approximately 50 mm square and having a thickness of approximately 0.3 mm) by alternately laminating SiO₂ thin films 2 and Nb₂O₅ thin films 3 for a total of approximately 100 layers using a sputtering device. The thickness of the multilayer optical thin film 4 is approximately 30 μm.

Besides silica, an optical material having a small linear expansion coefficient, e.g., Clearceram Z manufactured by Ohara Inc., Zerodur manufactured by Schott Co., Pyrex glass manufactured by Corning Inc, and Tempax glass manufactured by Schott Co., can also be used as the substrate 1.

The linear expansion coefficient of the multilayer optical thin film 4 is approximately 50×10⁻⁷/K (the linear expansion coefficient of Nb₂O₅ is 6.5×10⁻⁵/K, and the linear expansion coefficient of SiO₂ is 4 to 5×10⁻⁵/K). The linear expansion coefficient of conventional glass (BK7) is approximately 75×10⁻⁷/K, and is therefore greater than the linear expansion coefficient of the multilayer optical thin film 4. Accordingly, when the substrate 1 following the film formation is lowered to ordinary temperature, the compressive stress and the thermal stress act in the same direction, which further increases the deformation of the substrate 1.

In the present working configuration, the linear expansion coefficient of the substrate 1 is smaller than the linear expansion coefficient of the multilayer optical thin film 4. Accordingly, when the substrate 1 is lowered to ordinary temperature from the film formation state that is normally at approximately 200° C., the compressive stress of the multilayer optical thin film 4 and the thermal stress generated as a result of the temperature drop cancel each other out, so that the deformation (deflection) of the substrate 1 is reduced. Consequently, when the substrate 1 is cut by a dicing saw or the like, the working is easy, there is little damage, and the surface precision of the cut-out optical elements is improved.

Moreover, when the multilayer optical thin film 4 is to be formed, the film formation temperature can be adjusted in a range that does not interfere with the film formation conditions, and the thermal stress when the substrate 1 is returned to ordinary temperature can be adjusted in this manner; as a result, the deformation of the substrate 1 in the ordinary temperature state can be reduced.

The following method may be used as a method for accomplishing this: for example, after the material of the substrate 1 is determined, film formation is performed by varying the film formation temperature, and the film formation temperature which is such that the amount of deformation when the substrate 1 is placed in the ordinary temperature state is minimal is then found, so that the film formation is performed at this temperature.

In addition, when there are restrictions on the film formation temperature, the following method may be used: for example, film formation is performed at a specified film formation temperature with the material of the substrate 1 being varied, after which the material of the substrate 1 which is such that the amount of deformation when the substrate 1 is placed in the ordinary temperature state is minimal is found, and this material is used as the material of the substrate 1.

In addition to SiO₂ and Nb₂O₅, materials such as Ta₂O₅, TiO₂, ZrO₂, HfO₂, and Al₂O₃ and also materials that produce a compressive stress during the film formation can be used as substances that make up the thin film used in the present invention.

### EMBODIMENT

50-mm square silica with a thickness of 0.3 mm was used as the substrate 1 shown in FIG. 1, and 51 layers of SiO₂ films and 50 layers of Nb₂O₅ films were alternately formed on the surface of this silica by means of a sputtering device. The film formation temperature was approximately 200° C. The average thickness of one layer of SiO₂ was approximately 150 nm, and the average thickness of one layer of Nb₂O₅ was approximately 250 nm. The thickness of the multilayer optical thin film 4 formed in this manner was approximately 20 μm.

When the amount of deflection of the substrate 1 during the film formation was observed, it was approximately 1.1 mm. When the substrate 1 was lowered to ordinary temperature following the completion of the film formation, the amount of deflection of the substrate 1 was ameliorated to 0.5 mm.

Number of 8 mm×0.3 mm optical elements having a thickness of 0.3 mm were cut out by cutting this substrate with a dicing saw. When these elements were used sandwiched in waveguides, it was possible to fit the elements without any problem into grooves formed in the waveguides. Furthermore, it was possible to obtain the desired optical characteristics.

### COMPARATIVE EXAMPLE

Optical elements were manufactured in the same method as in Embodiment 1, except that glass (BK7) was used as the substrate 1.

When the amount of deflection of the substrate 1 during the film formation was observed, it was approximately 0.9 mm. When the substrate 1 was lowered to ordinary temperature following the completion of film formation, the amount of deflection of the substrate 1 deteriorated to 1.4 mm. That is, the amount became approximately three times the amount of deflection of the embodiment.

Number of 8 mm×0.3 mm optical elements having a thickness of 0.3 mm were cut out by cutting this substrate with a dicing saw. When these elements were used sandwiched in waveguides, there were elements that could not be fit into grooves formed in the waveguides. Furthermore, there were elements in which desired optical characteristics could not be obtained. This is estimated to be caused by fluctuations in the angle of incident due to the deflection on the surfaces of the optical elements.

1. An optical element that is formed by forming a thin film having a compressive stress on a substrate, wherein a material that has a linear expansion coefficient smaller than the linear expansion coefficient of the thin film and that has a thickness of 0.8 mm or less is used as the substrate.

2. The optical element according to claim 1, wherein a ratio of the thickness of the thin film to the thickness of the substrate is between 1:80 and 3:1.

3. P The optical element according to claim 1, wherein the thin film has a multilayer film structure.

4. The optical element according to claim 1, wherein the material is silica.

5. A method for manufacturing an optical element including a step of forming a thin film having a compressive stress on a substrate, wherein a material that has a linear expansion coefficient smaller than the linear expansion coefficient of the thin film and that has a thickness of 0.8 mm or less is used as the substrate, and a film formation is performed at a temperature which is such that the deformation of the substrate falls within a permissible range when the substrate having the thin film formed on the surface is returned to ordinary temperature following the completion of the film formation.

6. The method for manufacturing an optical element according to claim 5, wherein a ratio of the thickness of the thin film to the thickness of the substrate is between 1:80 and 3:1.

7. The method for manufacturing an optical element according to claim 5, wherein the thin film has a multilayer film structure.

8. The method for manufacturing an optical element according to claim 5, wherein the material is silica.
